(19) United States
(12) Patent Application Publication
(10) Pub. No.: US 2003/0126896 A1
(43) Pub. Date: Jul. 10, 2003

(54) Push-button lock device

(76) Inventor: Toshihiko Mori, Nishinomiya-shi (JP)

Correspondence Address: JOHN J. SWARTZ, SWARTZ & WILSON, 908 COURT STREET, SAGINAW, MI, 48602, US

(21) Appl. No.: 10/274,158

(22) Filed: Oct. 21, 2002

(30) Foreign Application Priority Data
Nov. 6, 2001 (JP) 2001-341127

(51) Int. Cl. E05B 13/00

(52) U.S. Cl. 70/214

(57) ABSTRACT

A push-button lock device is provided which allows to increase the combinations of unlocking numbers without increasing greatly the numbers of push-buttons and tumblers by enabling unlocking operation of a plurality of pushes to push the same push-button a plurality of number of times. In a push-button lock device having a plurality of push-buttons are provided on a holder case so as to be capable of extending and retracting in a surface thereof, a plurality of kinds of tumblers arranged to move toward a backside of the holder case when pushing the push-button and provided within the case correspondingly to the push-buttons, a slider provided within the holder case to move in a direction orthogonal to a moving direction of the tumbler, the slider urged in a lock position being allowed to an unlocking position by push-operating some of preset unlocking tumblers through the push-buttons, provided are a positioning mechanism for setting temporary fixing positions of the tumblers in a plurality of positions in a front-back direction of the holder case, and an intermediate mechanism for advancing, each time the push-button is pushed once, the temporary fixing position of the tumbler corresponding to the push-button toward the backside of the holder case one by one.

### BACKGROUND OF THE INVENTION

1. Technical Field of the Invention

The present invention relates to a push-button lock device arranged to release (unlock) the lock mechanism by pushing operation predetermined of bush-buttons provided on the holder case.

2. Description of the Related Art

Conventionally, there has been an arrangement of a push-button lock device having a plurality of push-buttons provided on the holder case so as to be capable of extending and retracting therefrom in a surface thereof. Within the case, tumblers are provided correspondingly to the push-buttons such that the push-button when pressed is moved toward the backside of the holder case and temporarily fixed in that position. A slider is provided within the holder case, to move in a direction orthogonal to a moving direction of the tumbler. By push-operating preset unlocking tumblers through the push-buttons, released is the lock mechanism provided within the holder case. (JP-B-2-40206U, JP-B-3-54281U, JP-B-3-78467U, JP-A-9-256695)

The lock mechanism, in this case, is structured such that a frame-plate formed slider having, in an inner periphery, convexes to engage one width side of each tumbler is slidably provided to move in a direction orthogonal to a moving direction of the tumbler within the holder case so that the rotation of the door knob (may be a door handle) is interlocked to the movement of the slider. Meanwhile, the tumbler is formed, in its widthwise one side, with a lock part and a release groove in different positions with respect to a push direction to engage with and disengage from the convex of the slider.

Consequently, when only a predetermined unlocking tumbler is pushed, engagement is released between all the tumblers and slider convexes to allow the slider to move. This releases locking to allow the rotation of the doorknob. In the other cases, however, any tumbler at its widthwise side engages the slider convex. This restricts the slider from moving and prevents the doorknob from rotating, thus providing a locked state.

On the other hand, the tumblers and a clear tumbler provided separately from them are all urged toward a surface of the holder case by return springs. Within the holder case, a clear actuator is provided so as to be capable of moving vertically similarly to the slider, which has positioning springs to engage the widthwise other sides of the unlocking and non-unlocking tumblers and hold these tumblers in the pushed position.

The clear actuator is inserted between the push-buttons arranged longitudinally in two rows and the tumblers. The unlocking and locking tumblers each have an engaging portion formed in a widthwise opposite edge thereof, to engage the positioning spring.

Meanwhile, a cam piece is formed in an edge of the clear tumbler to move the clear actuator. A slant cam surface the cam piece abuts against is formed in a lower end of the clear actuator. Consequently, when the clear button is pressed, the clear tumbler moves upward so that the positioning springs leave from the unlocking and non-locking tumblers. Thus, all the pressed tumblers return to their non-push positions.

In the conventional push-button lock device, the push-button pressed toward a backside of the holder case is placed in direct abutment against the tumbler to push the same tumbler toward the backside of the case. Accordingly, the temporary fixing position of the tumbler can be set in only one position with respect to a front-back direction of the holder case.

Consequently, the conventional push-button lock device allows for setting only with “once-push” of unlocking numbers (e.g. 1, 3, 5, 7 . . . ) wherein a certain push-button is pushed only once. It is impossible to set with “a plurality of pushes” of unlocking numbers (e.g. 1, 1, 3, 3 . . . ) by pushing a certain push-button a plurality of number of times.

Accordingly, in order to increase the combinations of unlocking numbers in the conventional push-button lock device, there is a need to arrange push-buttons and tumblers as many as possible. Thus, there is a defect that the holder case must be increased in vertical or widthwise size in proportion to the purpose of improving security.

It is an object of the present invention to provide, in view of such circumstances, a push-button lock device which allows to increase the combinations of unlocking numbers without increasing greatly the numbers of push-buttons and tumblers by enabling unlocking operation with a plurality of pushes to push the same push-button a plurality of number of times.

Other objects and advantages of the present invention will become apparent to those of ordinary skill in the art as the description thereof proceeds.

### SUMMARY OF THE INVENTION

In order to achieve the above object, the present invention takes the following measures:

Namely, the invention is characterized in that: in the foregoing push-button lock device are provided a positioning mechanism for setting temporary fixing positions of the tumblers in a plurality of positions in a front-back direction of the holder case, and an intermediate mechanism for advancing, each time the push-button is pushed once, the temporary fixing position of the tumbler corresponding to the push-button toward the backside of the holder case one by one.

According to the invention, the temporary fixing position of the tumbler is set in a plurality of positions with respect to the front-back direction of the holder case by the positioning mechanism, and the intermediate mechanism is provided for advancing, each time the push-button is pushed once, the temporary fixing position of the tumbler corresponding to the push-button toward the backside of the holder case one by one. Accordingly, unlocking operation with pushes in plurality can be made to first release the lock by pushing the same push-button a plurality of number of times.

Hereunder, the preferred embodiments of the invention will be explained on the basis of the content of the dependent claims.

Namely, in the invention, the positioning mechanism concretely has a return spring urging the tumbler onto a former unpushed position, a plurality of engaging portions formed in the tumbler in different positions with respect to the front-back direction of the holder case, a positioning spring for being caught by any of the engaging portions to temporarily fix the tumbler.

In this case, by disengaging the positioning spring from the engaging portion of the tumbler by any release means, the tumbler can be returned to the former unpushed position due to the urge force of the return spring. However, such tumbler returning operation if individually made, the clear operation upon eroneously pressing a release number may be extremely troublesome.

Consequently, it is recommended that the invention further comprises a clear actuator having a plurality of positioning springs to be caught by the engaging portion to temporarily fix the tumbler and being movable in a direction orthogonal to a moving direction of the tumbler. In the case of providing a clear actuator, by merely moving the clear actuator in a direction orthogonal to a moving direction of the tumbler, all the positioning springs disengage from the engaging portions of the tumblers. By the urge force of the return springs, all the tumblers can be returned at once to the unpushed position.

Incidentally, by providing a clear tumbler for moving the clear actuator in order to disengage the positioning spring from the engaging portion of the tumbler and a clear button for push-operate this tumbler, clear operation with the relevant clear actuator can be made by merely pushing the clear button.

Meanwhile, in the invention, the intermediate mechanism concretely is structured with a plurality of engaging projections formed in different positions with respect to the front-back direction of the holder case, and a push-in arm having a tip to be caught by any of the engaging projections and a base coupled to the push-button.

In this case, in order to positively engage the tip of the push-in arm with the engaging projection of the unlocking tumbler, should the tip of the arm be arranged always in the passage region of the tumbler, even in performing clear operation by the clear actuator, the engaging projection of the unlocking tumbler is caught by the tip of the arm. Thus, the unlocking tumbler cannot be returned at once to the former unpushed position.

Consequently, it is recommended that the invention further comprises a retraction member for swing-moving the push-in arm such that a tip of the push-in arm is out of a passage region of the tumbler when the push-button is not pushed, and the tip first enters the passage region when the push-button is pushed.

In this case, when the push-button is not pushed, the tip of the push-in arm is swung by the retraction member to the out of the passage region of the unlocking tumbler. Accordingly, when the unlocking tumbler is returned to the former unpushed position by the clear operation of the clear actuator, the tumbler can be positively returned to the former unpushed position without being caught at the engaging projection by the arm tip. Thus, clear operation can be positively made by the clear actuator.

### DESCRIPTION OF THE DRAWINGS

The invention may be more readily understood by referring to the accompanying drawings, in which:

FIG. 1 is a cross-sectional view of a push-button lock device taken in a position corresponding to a first unlocking tumbler (state prior to pushing the push-button);

FIG. 2 is a cross-sectional view of the push-button lock device taken in a position corresponding to the first unlocking tumbler (state the push-button is pushed);

FIG. 3 is a cross-sectional view of the push-button lock device taken in a position corresponding to a second unlocking tumbler (state prior to pushing the push-button);

FIG. 4 is a cross-sectional view of the push-button lock device taken in a position corresponding to the second unlocking tumbler (state after pushing the push-button twice);

FIG. 5 is a longitudinal sectional view of the push-button lock device shown by magnifying the part corresponding to the tumbler;

FIG. 6A is a front view of a non-unlocking tumbler, FIG. 6B is a side view of a non-unlocking tumbler, FIG. 6C a front view of a first unlocking tumbler, FIG. 6D a side view of the first unlocking tumbler, FIG. 6E a front view of a second unlocking tumbler and FIG. 6F a side view of the second unlocking tumbler;

FIG. 7 is a longitudinal sectional view of a push-button lock device in a state fitted on a door;

FIG. 8 is a front sectional view of a push-button lock device to show an interior mechanism;

FIG. 9A is a front view of a push-button lock device and FIG. 6B a left side view of the push-button lock device;

FIG. 10C is a plan view of the push-button lock device and FIG. 10D a backside view of the push-button lock device; and

FIG. 11 is a perspective view showing a mailbox and gathering mailbox employing a push-button lock device of the invention.

### DETAILED DESCRIPTION OF THE INVENTION

The embodiments of the present invention will now be explained with reference to the drawings.

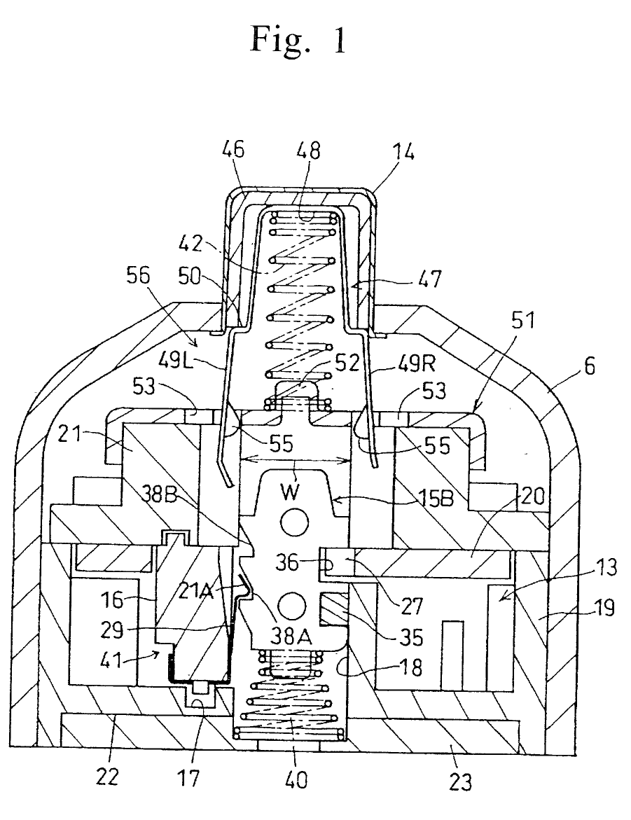

FIGS. 1 to 10 exemplify a push-button lock device according to a first embodiment of the invention. The push-button lock device 1 is employed as a lock device to lock a front door 2.

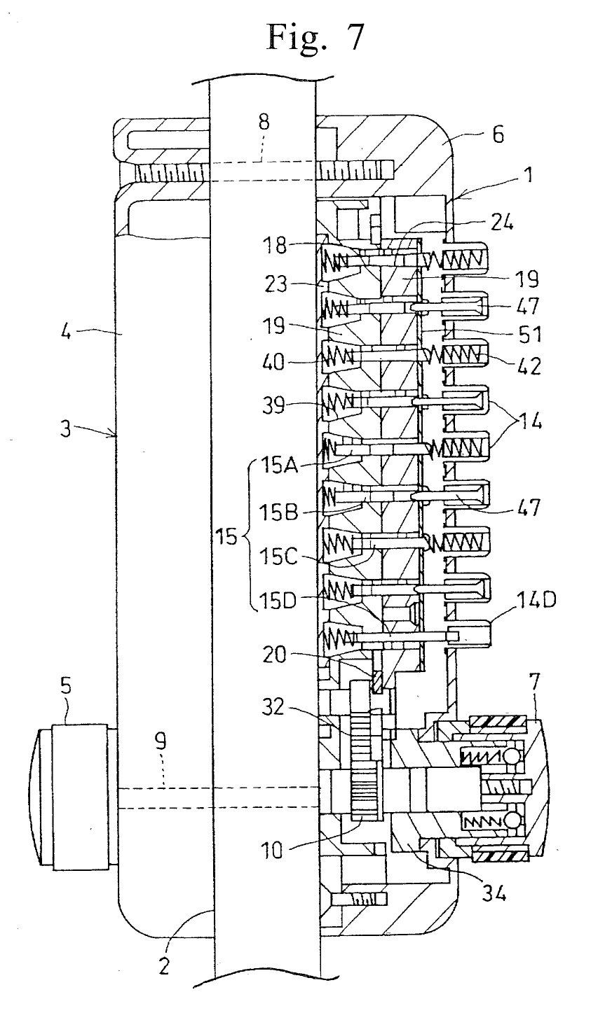

As shown in FIG. 7, the lock device 1 of this embodiment is fixed on a door 2 in its outer side surface. The door 2 has a door latch (not shown) to extend from and retract in an end surface of a free end thereof. The door latch is to be engaged with and disengaged from a latch receiving metal-piece provided on a doorframe.

An operating mechanism 3 is provided on an indoor surface of the door 2 in a position corresponding to the lock device 1. The operating mechanism 3 is structured with a ornamental lid 4 in an elongate rectangular-dish form attached on the door 2 in its indoor side and an operating member (may be a lever) made by an indoor knob 5.

As shown in FIGS. 7 to 10, the push-button lock device 1 provided at the outdoor side has a holder case 6 in a vertically long box form attached on the door 2 at an outdoor side and opened at its backside, and an operating member (may be a lever) made by an outdoor knob 7 rotatably provided at a lower end of the case 6. The ornamental lid 4 and the holder case 6 are fixed in corresponding positions at the indoor and outdoor of the door 2 by an attaching bolt 8 penetrating the door 2 from the indoor side.

The holder case 6 is a metal-make hollow member having nearly the same outer shape as the indoor ornamental lid 4 and opened at the backside. All the structural members required for the push-button lock device 1 are assembled within the holder case 6. The indoor knob 5 and the outdoor knob 7 are arranged in a coaxial relationship and interlocked each other through a latch drive shaft 9 penetrating the door 2.

The latch drive shaft 9 is in an elongate flat plate form and has an indoor end fitted to a hub of the indoor knob 5. The outdoor end of the drive shaft 9 is inserted through a drive pinion coaxially fixed to an inner side of the outdoor knob 7. Consequently, by rotating the latch drive shaft 9 in any direction of left and right due to the knob 5, 7, the door latch is retracted in the door 2.

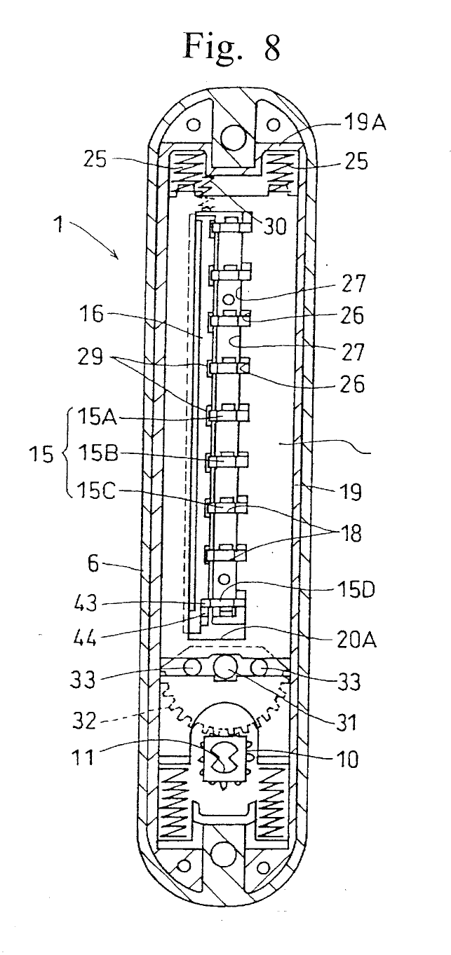

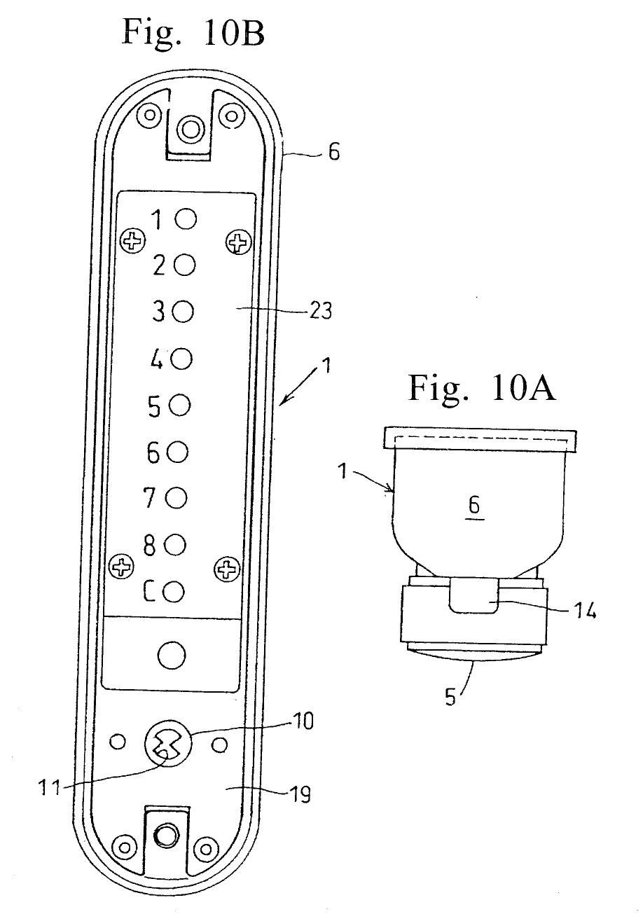

The latch drive shaft 9 is inserted through a fan-formed hole (see FIGS. 8 and 10) of the drive pinion 10, with a play in a rotation direction. When a lock mechanism 13 hereinafter referred is in a locked state, the pinion 10 is restricted from rotating so that the outdoor knob 7 cannot rotate in an unlocking direction. When the lock mechanism 13 is unlocked, the pinion 10 is allowed to rotate so that the outdoor knob 7 can rotated in the unlocking direction.

The push-button lock device 1 of the embodiment has a plurality (totally nine in this embodiment) of push-buttons 14 provided extendably and retractably in the surface of the holder case 7 and a plurality of tumblers 15 arranged correspondingly to the push-buttons 14 to move toward the backside of the holder case 7 when the push-button is pressed down. By pressing some preset unlocking tumblers 15B, 15C toward the backside of the holder case 6 due to the push-button 14, the lock mechanism 13 is released within the holder case 6.

The lock mechanism 13 in the holder case 6 has, as shown in FIGS. 1 to 4, a guide groove 17 for a clear actuator 16 long vertically (lengthwise of the holder case 6), a base 19 having a plurality of tumbler insertion holes 18 vertically arranged equi-spaced adjacent to the guide groove 17, a slider 20 slidably superposed on the base 19 at an outdoor side (the upper side in FIG. 1), a tumbler support base 21 superposed on the slider 20 at its outdoor side, and a back lid 23 removably closing an opening 22 formed in the back surface of the base 19.

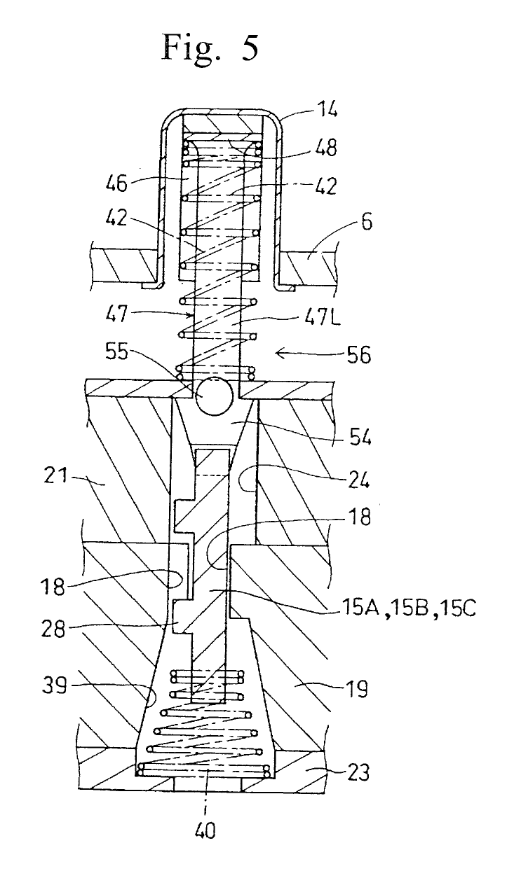

The tumblers 15 are respectively inserted in the tumbler insertion holes 18 of the base 19 to move in a front-back direction (in an indoor-outdoor direction). The tumblers 15 are respectively inserted also in the tumbler insertion holes 24 (see FIG. 5) provided in the tumbler support base 21.

As shown in FIG. 8, the slider 20 is a plate frame member having a size in an extent to encompass all the tumbler insertion holes 18 (hence surrounding all the tumblers), and arranged within the base 19 movably in a lengthwise direction thereof (vertical direction in FIG. 8). The slider 20 is formed, at its upper left and right ends, protuberances respectively fitted with compression springs 25. By abutting the top ends of the compression springs 25 against an upper end plate 19A of the base 19, the slider 20 is urged downward at all times.

Incidentally, the slider 20 in a frame form may be in a non-continuous shape cut out in part thereof. The slider 20, in one frame inner edge, is formed with concaves 26 and convexes 27 continuously in a slide direction of the slider 20, to engage with and disengage from each tumbler 15 at its widthwise one edge thereby restricting against and allowing for the movement of the slider 20.

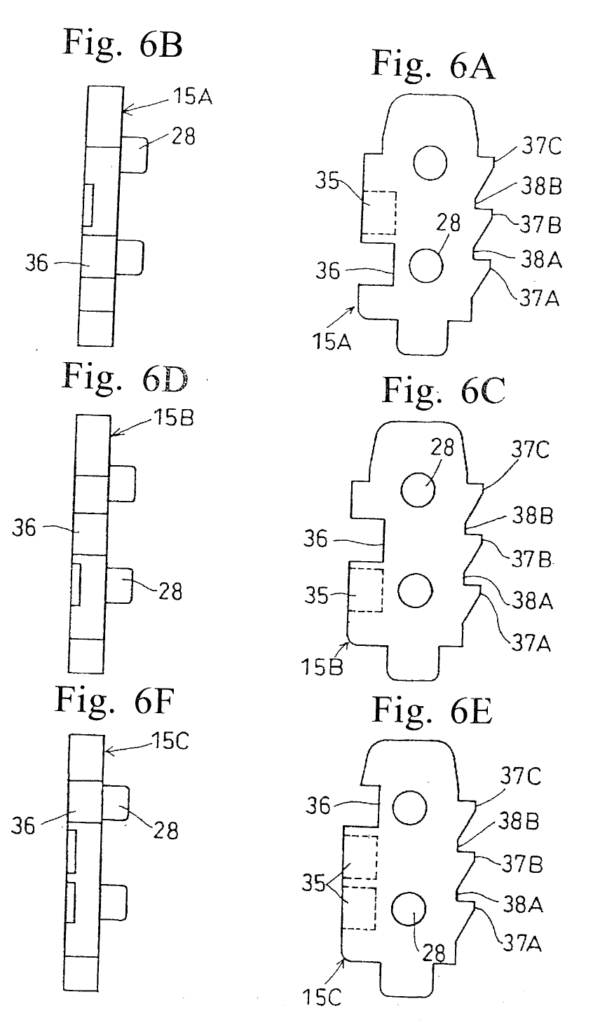

This embodiment prepares, as the tumbler 15 provided corresponding to the push-button 14, totally four kinds, i.e., a non-unlocking tumbler 15A (FIGS. 6A and 6B) for allowing the slider 20 to move in an unpushed state, a first unlocking tumbler 15B for allowing the slider 20 to move by being pressed only once (FIGS. 6C and 6D), a second unlocking tumbler 15C for allowing the slider 20 to move by being pressed only twice (FIGS. 6E and 6F), and a clear tumbler 15D for actuating the clear actuator 16 (FIG. 8).

Incidentally, the tumblers 15A to 15D are arranged, together with the corresponding push-buttons 14, in a longitudinal line in a central region of the holder case 6. The clear tumbler 15D and the corresponding clear button 14D (push-button 14 for pushing the clear tumbler 15D) are arranged in the lowermost. Meanwhile, as shown in FIG. 6, a guide pin 28 projects at a widthwise center of each tumbler 15A to 15C for non-unlocking, first unlocking and second unlocking, in order to prevent erroneously recognize an insertion direction to the base 19.

In the guide groove 17 of the base 19, the clear actuator 16 is slidably provided vertically similar to the direction of movement of the slider 20. The clear actuator 16 has, at a predetermined longitudinal interval, positioning springs 29 in a thin leaf spring form to hold each tumbler 15 pushed by the push-buttons 14 in the pushed positions, as shown in FIG. 8. Meanwhile, the clear actuator 16 is always urged down independently of the slider 20 by a descent spring 30 inserted between an upper end of the actuator 16 and an upper plate 19A of the base 19.

Meanwhile, as shown in FIG. 8, the clear actuator 16 is arranged at an inside of the frame of the slider 20 so that a lower end thereof can abut against a lower side 20A of the slider 20. Consequently, when the slider 20 moves upward (toward the release), the clear actuator 16 also is moved upward by the interlock therewith whereby the positioning springs 29 respectively disengage from the tumblers 15.

As shown in FIGS. 7 and 8, at the above of the drive pinion 10 is provided a sector gear 32 in mesh with the pinion 10 to rotate about a support axis 31 in a direction of the indoor and outdoor. The release pins 33 fixed at left and right ends of the sector gear 32 abut against the lower end edge of the slider 20. Consequently, in a locked state the slider 20 is restricted from moving upward, the release pins 33 abutting against the lower end edge of the slider 20 prevents the sector gear 32 from rotating and also the outdoor knob 7 from rotating. Conversely, in an unlocked state the slider 20 is allowed to move upward, the release pins 33 are allowed to revolve about the support shaft 31 of the sector gear 32 and also the outdoor knob 7 is allowed to rotate.

On the support shaft 31 of the sector gear 32 at an outdoor side, spline-fitted is a bearing 34 screwed to the outdoor knob 7. A not-shown coiled spring is fitted around an outer periphery of the bearing 34. By the elastic force of the coiled spring, the outdoor knob 7 after rotation is returned to the normal state.

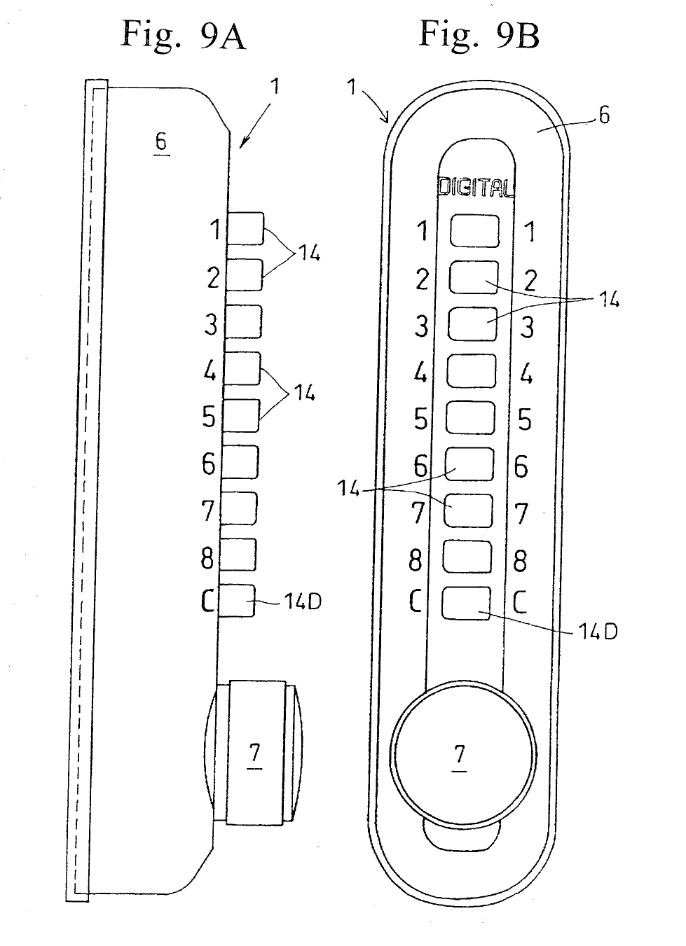

As shown in FIG. 9, this embodiment has Arabic numerals “1”-“8” and an English character “C” inscribed on the left and right sides of the relevant press-buttons 14 on the surface of the holder case 6, correspondingly to the press-buttons 14. Of among these numerals and characters, the press-buttons 14 corresponding to the numerals “1”-“8” are given correspondence to any one of the non-unlocking tumbler 15A, the first unlocking tumbler 15B and the second unlocking tumbler 15C. Meanwhile, the press-button 14 corresponding to the symbol “C” in the lowermost position (clear button 14D) is given correspondence to the clear tumbler 15D.

As shown in FIGS. 1 to 4 and 6, each of the unlocking and non-unlocking tumblers 15A to 15C other than the clear tumbler 15D is formed, at widthwise one edge, with a lock part 35 for restricting the convex 27 of the slider from passing and a release groove 36 for allowing the convex 27 to pass. On the other hand, each of the tumblers 15A to 15C has, in the other widthwise edge, totally three triangular projections 37A to 37C each having a nearly horizontal top side formed at a predetermined interval in a front-back direction of the holder case 6. By the triangular grooves formed between the three engaging projections 37A to 37C, totally two engaging portions 38A, 38B are formed spaced in the front-back direction of the holder case 6, which are to be engaged with a tip engaging portion 29A of the positioning spring 29.

Namely, each tumbler 15A to 15C of this embodiment has the three engaging projections 37A to 37C and two engaging portions 38A, 38B formed on the widthwise same side of the tumbler 15A to 15C. In the case that the three engaging projections 37A to 37C are defined as a first engaging projection 37A, a second engaging projection 37B and a third engaging projection 37C in the order of from the backside with respect to the front-back direction of the holder case 6 (from the lower in FIG. 6), the first engaging portion 38A on the back side is formed between the first engaging projection 37A and the second engaging projection 37B while the second engaging portion 38B on the front side is formed between the second engaging projection 37B and the third engaging projection 37C.

The unlocking and non-unlocking tumblers 15A to 15C are respectively received in the tumbler insertion holes 18, in a position directing the region forming the engaging projections 37A to 37C and engaging portions 38A, 38B toward the clear actuator 16. Meanwhile, spring accommodating portions 39 (see FIG. 7) are formed in the backside of the base 19 in positions corresponding to the tumblers 15 (including the clear tumbler 15D). The accommodating portion 39 accommodates therein the return spring 40 to urge the tumbler 15 toward the surface of the holder case 6 (toward the upper in FIG. 1).

Accordingly, when the unlocking or non-unlocking tumbler 15A to 15D is pressed down toward the backside of the holder case 6 by a pressing arm 49L hereinafter referred, the engaging portion 38A, 38B is brought into engagement with the tip engaging portion 29A of the positioning spring 29 and temporarily fixed in its pushed position. However, when the clear actuator 16 is moved upward by the clear tumbler 15D, the engaging portion 38A, 38B and the positioning spring 29 are released from engagement, the tumbler 15A to 15D are pushed toward the surface of the holder case 6 by the return spring 40 and returned to the former position.

Meanwhile, in this embodiment, because the two engaging portions 38A, 38B are formed spaced in the front-back direction in each tumbler 15A to 15C, totally two stages of temporary fixing positions (hence, excepting the former unpushed position) are set in the front-back direction where the tumbler 15A to 15C is pressed down toward the backside of the holder case 6.

Thus, in this embodiment, a positioning mechanism 41 is structured by the return springs 40 to urge the tumbler 15A to 15C toward the former unpushed position, the two engaging portions 38A, 38B of the tumbler 15A to 15C formed in positions spaced in the front-back direction of the holder case 6, and the positioning springs 29 to engage any of the engaging portions 38A, 38B to temporarily fix the tumbler 15A to 15C, whereby the temporary fixing position of the tumbler 15A to 15C is set in two positions in the front-back direction of the holder case 6.

As shown in FIG. 6, of among the non-unlocking, first unlocking and second unlocking tumblers 15A to 15C, the non-unlocking tumbler 15A (FIGS. 6A and 6B) has a release groove 36 in the holder case 6 in a position close to the backside with respect to the front-back direction thereof (the lower in FIG. 6). The release groove 36, when the tumbler 15A is in the unpushed position, is coincident with the slider 20.

Meanwhile, the first unlocking tumbler 15B (FIGS. 6C and 6D) has a release groove 36 nearly in a center of the holder case 6 with respect to the front-back direction thereof. The release groove 36, when the positioning spring 29 is caught in the first engaging portion 38A, is coincident with the slider 20. Furthermore, the second unlocking tumbler 15C (FIGS. 6E and 6F) has a release groove 36 in the holder case 6 in a position close to the surface with respect to the front-back direction thereof. The release groove 36, when the positioning spring 29 is caught in the second engaging portion 38B, is coincident with the slider 20.

Accordingly, concerning the non-unlocking tumbler 15A, when this is pushed even once, the lock part positions 35 in the frame of the slider 20 to move in the concave 26 and engages the convex 27 of the slider 20 whereby the slider 20 is restricted from moving upward. Meanwhile, when the non-unlocking tumbler 15A is in the former unpushed position, its release groove 36 positions in the frame of the slider 20 so that the slider 20 at its convex 27 goes out of contact with the tumbler 15A.

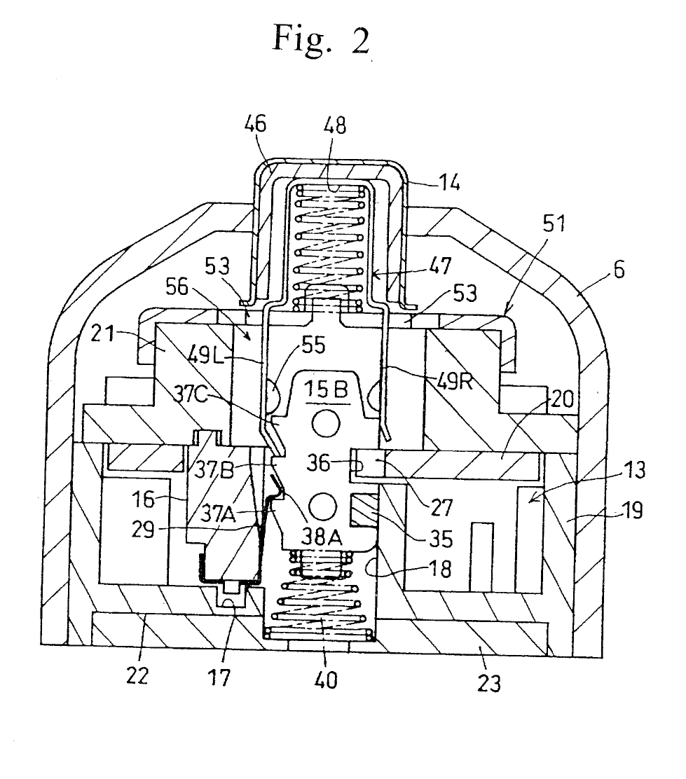

Meanwhile, concerning the first unlocking tumbler 15B, when this is not pushed or pushed twice, its lock part 35 positions in the frame of the slider 20 to move in the concave 26 and engages the convex 27 of the slider 20 whereby the slider 20 is restricted from moving upward. When the first unlocking tumbler 15B is pushed only once, its release groove 36 positions in the frame of the slider 20 so that the slider 20 at its convex 27 goes out of contact with the tumbler 15B (see FIGS. 1 and 2).

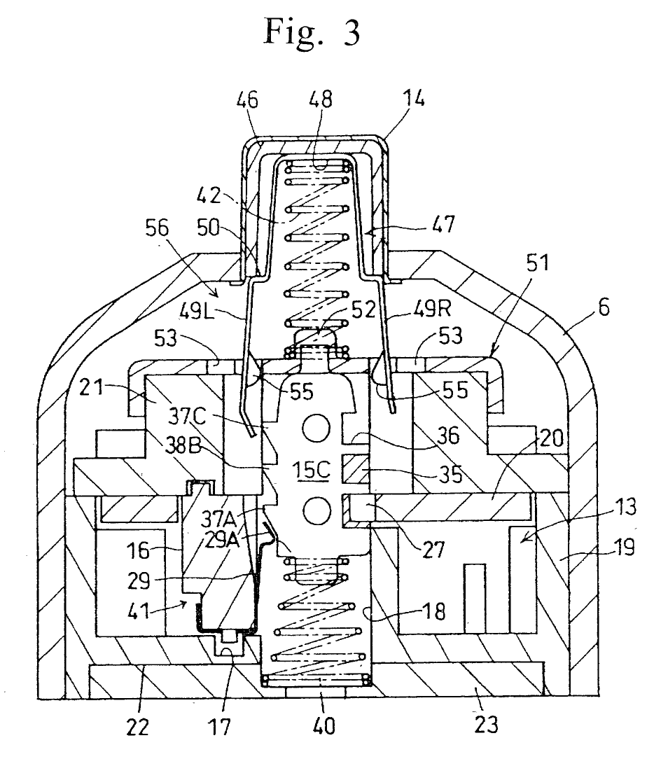

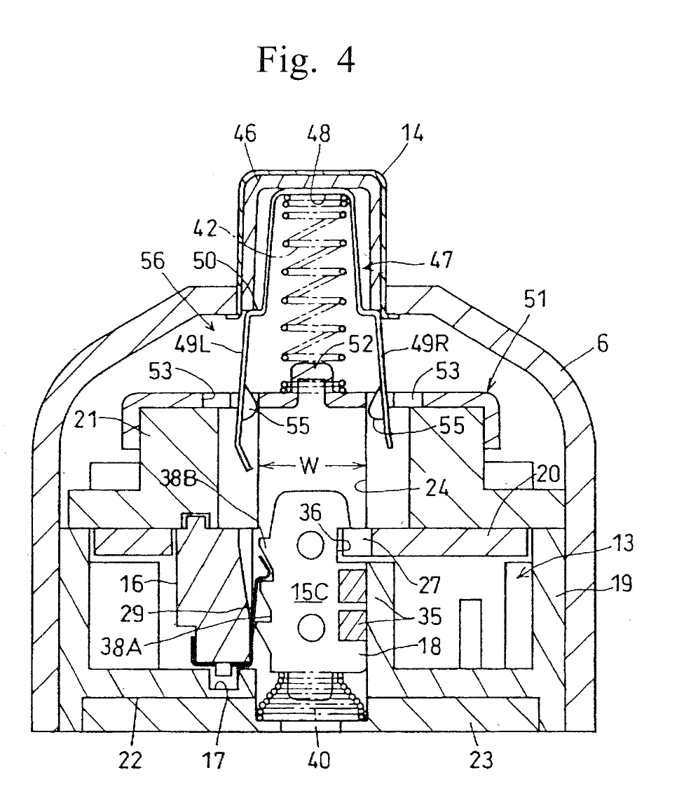

On the other hand, concerning the second unlocking tumbler 15C, when this is not pushed or pushed once, its lock part 35 positions in the frame of the slider 20 to move in the concave 26 and engages the convex 27 of the slider 20 whereby the slider 20 is restricted from moving upward (see FIG. 3). Also, when the second unlocking tumbler 15C is pushed twice, its release groove 36 positions in the frame of the slider 20 so that the slider 20 at its convex 27 goes out of contact with the tumbler 15C (see FIG. 4).

Consequently, only when the preset first and second unlocking tumblers 15B, 15C are pressed a predetermined number of times, the slider 20 is allowed to move upward thereby unlocking the lock mechanism 13. In the other cases (e.g. non-unlocking tumbler 15A is pressed or unlocking tumbler 15B, 15C is mistakenly pressed in the number of times of depression or so) however, the slider 20 is restricted from moving upward by the lock part 35 of any of the tumblers 15A to 15C thereby maintaining the locking state of the lock mechanism 13. Note that, in FIGS. 1 to 4, the lock part 35 of the tumbler 15 is hatched and clearly distinguished from the release groove 36 without having hatching.

The push-button 14 is formed with a bottom but opened at the backside, and inserted in the holder case 6 to extend toward and retract from the outdoor in a state not to be removed from the surface. The push-button 14 is received therein with a return spring 42. The return spring 42 has an inner end fitted over a projection of a retraction member 51 hereinafter referred. Consequently, after the push-button 14 is pressed down toward the backside of the case 6 to press the tumbler 20, only the relevant press-button 14 can be automatically returned to the former position by the return spring 42.

The clear tumbler 15D is for moving the clear actuator 16 upward to return the unlocking or non-unlocking tumbler 15A to 15C to the former unpushed position. As shown in FIG. 8, the clear tumbler 15D has a cam piece 43 having a cut-out in a widthwise end thereof. The clear actuator 16 has a slant cam surface 44 with which the cam piece 43 is in engagement.

Consequently, when the clear tumbler 15D is pushed down by the push-button 14 (clear button 14) corresponding to the symbol “C”, the clear actuator 16 is moved upward against the descend spring 30 by the engagement of between the cam piece 43 and the slant cam surface 44. On this occasion, because the positioning spring 29 projecting from the clear actuator 16 is also moved upward, the positioning spring 29 and the tumbler 15A to 15C are released from engagement. The tumbler 15A to 15C pushed to a temporary position is returned to the former position by the return spring 40.

As shown in FIGS. 1 to 4, a reinforcing frame 46 having a groove form in section is fixed inside the push-button 14. On the bottom of the reinforcing member 46, a push-in member 47 is fixed so that, each time the push-button 14 is pushed once, the reinforcing member 46 at its bottom is caught by the first engaging projection 37A and second engaging projection 37B of the tumbler 15A to 15C in the order. By such engagement, the tumbler 15A to 15C is advanced in its temporary fixing position one by one toward the backside.

The push-in member 47 has a fixing plate 48 fixed on the bottom of the reinforcing member 46 and a pair of push-in arms 49L, 49R in left and right formed by leaf springs extending downward from the both ends of the fixing plate 48. The return spring 42 at one end abuts against the fixing plate 48 of the push-in member 47. Meanwhile, the push-in arms 49L, 49R has a step 50 formed in a longitudinal (vertical in FIG. 1) center thereof, which extends widthwise of the holder case 6.

Of the pair of push-in arms 49L, 49R in left and right, the left arm 49L has a tip somewhat bent toward the tumbler 15 so that it can be caught by the engaging projection 37A, 37B. The right arm 49R has a tip somewhat bent toward leaving from the tumbler 15. The arms 49L, 49R are bent rectangular to the fixing plate 48 such that the arms 49L, 49R are parallel with each other in a natural state no load is applied to them. The distance between the both arms 49L, 49R in the parallel state is slightly smaller than the widthwise size of the tumbler 15.

As shown in FIGS. 1 to 5, the base 19 at its outdoor side is superposed with a retraction member 51 to put the push-in member 47 in an apart form where the push-button 14 is not pushed. The retraction member 51 is formed, in its widthwise center, with a short-cylindrical projection 52 projecting toward the surface of the holder case 6. The projection is fitted to the other end of the return spring 42.

A pair of guide holes 53 are formed on the both left and right sides of the projection 52 of the retraction member 51. The left and right push-in arms 49L, 49R at their tips are respectively inserted in the guide holes 53. The push-in arm 49L, 49R is formed, at a tip, with a triangular head 54 (see FIG. 5) having an anti-removal function from the guide hole 53. A cam projection 55 projects in the plane the left and right heads 54 faces to each other, which engages an edge of the guide hole 53 to spread the push-in arms 49L, 49R widthwise outward.

As shown in FIG. 1, the cam projection 55, in a state the push-button 14 is not pushed, positions at an inside of the guide hole 53 of the retraction member 51, wherein the push-in arm 49L, 49R at its tip is out of the passage region W of the tumbler 15. On the other hand, as shown in FIG. 2, when the push-button 14 is pushed, the cam projection 55 moves toward the backside of the holder case 6 and leaves from the guide hole 53 of the retraction member 51. At this time, the left arm 49L at its tip enters the passage region W of the tumbler 15 and is caught by any of the engaging projections 37A, 37B. Simultaneously, the right arm 49R at its tip also enters the passage region W and contacts a widthwise edge of the same tumbler 15.

In a state the left arm 49L at the tip is caught by any of the first and second engaging projections 37A, 37B, when the push-button 14 is further pushed down, the tumbler 15 is pushed toward the backside of the holder case 6 by the tip of the left arm 49L while being clamped widthwise oppositely by the left and right arms 49L, 49R. Thereafter, a tip engaging portion 29A of the positioning spring 29 fits in the engaging portion 38A, 38B positioned deeper by one, whereby the tumbler 15 is positioned in the next temporary position.

In this manner, this embodiment is structured with an intermediate mechanism 56 by the first and second engaging projections 37A, 37B formed in each tumbler 15A to 15C and the left arm 47L of the push-in member 47 to engage any one of the engaging projections 37A, 37B, so that, each time the push-button 14 is pushed once, the tumbler 15A to 15C corresponding to the push-button 14 is advanced in its temporary fixed position.

Meanwhile, the push-in member 47 of this embodiment has the push-in arms 47L, 47R in left-and-right pair to abut against and clamp the tumbler 15A to 15C at its widthwise opposite edges when pushing it out. Thus, the function is also provided to move the tumbler 15A to 15C toward the backside of the holder case 6 while oppositely clamping it widthwise.

Now, explanation will be made on the using method and operation of the push-button lock device 1 according to the foregoing structure.

At first, it is assumed that, for example, unlocking number “1, 3, 3, 5, 5, 6” is set of among the combinations of unlocking numbers using the eight push-buttons 14 assigned with the numbers “1” to “8”.

In this case, the tumblers 15A to 15C are received in the tumbler insertion holes 18 such that the first unlocking tumbler 1 5B corresponds to the numbers “1” and “6” of push-buttons, the second unlocking tumbler 15C corresponds to the numbers “3” and “5” of push-buttons and the non-unlocking tumbler 15A corresponds to the other numbers “2”, “4”, “7” and “8” of push-buttons.

In order to unlock the push-button lock device 1, the push-button numbered “1” may be pushed once, the push-buttons 14 numbered “3” and “5” be respectively pushed twice and, further, the push-button 14 numbered “6” be pushed once, followed by rotating the outdoor knob 7.

Thereupon, all the tumblers 15A to 15C are released from the engagement between the lock part 35 and the convex 27 of the slider 20, thus allowing the slider 20 to move upward. This allows the outdoor knob 7 to rotate. By rotating this, the latch 2 of the door 2 is drawn. Thus, the door 2 is released from locking.

On the other hand, in the case that the push-button 14 is pushed with a mistakenly unlocking number, i.e. as in the followings (1) to (3), the lock part 35 of any of the tumblers 15A to 15C engages the convex 27. This restricts the slider 20 from moving upward thus maintaining the lock state of the outdoor knob 7 being not allowed to rotate.

(1) Where pressing a push-button 14 with the number “2”, “4”, “7” or “8” corresponding to the non-unlocking tumbler 15A.

(2) Where not or twice pressing a push-button 14 with the number “1” or “6” corresponding to the first unlocking tumbler 15B.

(3) Where not or only once pressing a push-button 14 with the number “3” or “5” corresponding to the first unlocking tumbler 15B.

Incidentally, when the user mistakenly pressed with unlocking number, pushing the “C” push-button 14 (clear button 14D) actuates the clear actuator 16 due to the clear tumbler 15D, to return all the tumblers 15A to 15C to the former unpressed position. Thereafter, correct unlocking number may be re-pushed.

In this manner, according to the push-button lock device 1 of this embodiment, the temporary fixed position of the tumbler 15A to 15C is set to two positions in a front-back direction of the holder case 6. Furthermore, a push-in arm 49R is provided on the push-button 14 to advance the temporary fixed position of the tumbler one by one toward the backside of the holder case 6 each time the push-button 14 is pushed once. Moreover, Because all the tumbler 15 employs, as one part, a second unlocking tumbler 15C to release the engagement from the slider 20 when advanced twice toward the backside of the holder case 6, twice-pressing unlock operation is feasible wherein lock is first released by pushing the same button 14 twice.

Consequently, the combination of unlocking numbers can be greatly increased without greatly increasing the number of the push-buttons 14 and tumblers 15. Thus, it is possible to greatly improve the security of the push-button lock device 1 without increasing the size of the holder case 6.

Meanwhile, according to the push-button lock device 1 of the present embodiment, the tumbler 15A to 15C is moved toward the backside of the holder case 6 while being sandwiched by a push-in member (push-in mechanism) 47 provided for each push-button 14. Accordingly, even where, for example, the user presses the push-button 14 at a position other than the center of the button 14 or presses the push-button in direction somewhat tilted with respect to the front-back direction of the holder case 6, the force of push is prevented from conveyed with deviation to one part of the tumbler 15A to 15C.

Consequently, eliminated is tangle in the tumbler 15A to 15C upon pressing the push-button 14. The push-button can be pushed with comparatively light touch, thus facilitating unlock operation by the push-button 14.

Furthermore, in the push-button lock device 1 of this embodiment, when the push-button 14 is not operated, the left arm 49L at its tip is placed out of the passage region W of the tumbler 15A to 15C by the retraction member 51. Accordingly, when the tumbler 15A to 15C returns to the former position due to clear actuation by the clear actuator 16, its engaging projection 37A, 37B will not be caught by the tip of the left arm 49L. Consequently, the tumbler 15A to 15C can be positively returned to the former unpushed position. Clear actuation can be positively made by the clear actuator 16.

Meanwhile, in the case of this embodiment, when the push-button 14 is not operated, the both arm 49L, 49R in left and right structuring a push-in member 47 are both spread in a state positioned out of the passage region W of the tumbler 15A to 15C by the retraction member 51. The both arms 49L, 49R at their tips first enter the passage region W by operating the push-button 14. It is therefore possible to suppress to a minimum the friction due to contact of the tips of the both arms 49L, 49R with the widthwise both edge of the tumbler 15A to 15C.

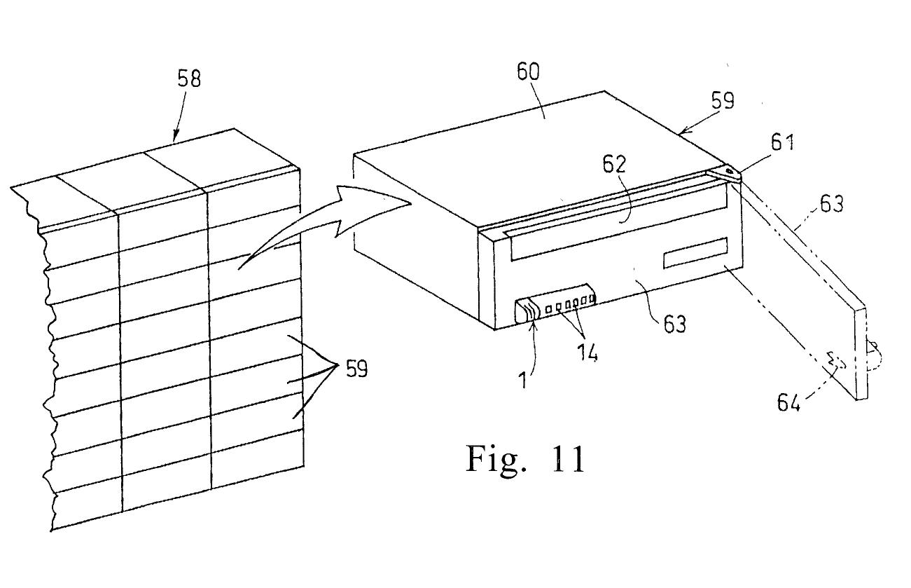

FIG. 11 exemplifies a push-button lock device 1 according to a second embodiment of the invention. The push-button lock device 1 is employed as a lock device for locking the individual mailbox structuring a gathering mailbox 58.

As shown in the figure, the gathering mailbox 58, installed in the front of a gathering house such as a condominium, is structured with a number of mailboxes 59 coupled vertically and horizontally to accommodate a delivery to each of the residents. The mail box 59 has a metal-make box main body 60 opened at the front, and an open-close lid 63 pivotally provided for opening and closing on an aperture of the box main body 60 through a hinge 61 and having a mail reception port 62 in an upper part.

The push-button lock device 1 of this embodiment is fixed on the open-close lid 63 in a lower part on a free-end side so that, by unlock-operate the push-buttons 14, the latch 64 provided on the backside of the open-close lid 63 can be first released from the latch receptor (not shown) on a side of the box main body 60. Note that the internal mechanism of the push-button lock mechanism 1 is similar to that of the first embodiment and the detailed explanation thereof is omitted.

In this manner, according to the push-button lock device of this embodiment, unlock operation is possible with twice of pushes. Consequently, because sufficiently complicated unlocking number can be set without greatly increasing the number of push-buttons 14 and tumblers 15, the holder case 6 can be made compact to a possible degree. It is possible to use as a locking device of the mailbox 59 shown in FIG. 11.

Incidentally, the content of the present invention is determined by the claims without limitation to the foregoing embodiments.

For example, the foregoing embodiments explained on the lock device 1 that unlock operation is possible with twice pushes. However, by further increasing the number of the engaging projections 37 of the tumbler 15 and engaging portions 38, a push-button lock device 1 is obtained which first unlocks by pushing a certain push-button 14 trice or more.

As explained above, according to the present invention, unlocking operation with pushes a plurality of number of times is possible wherein the same push-button is pushed a plurality of number of times. Accordingly, the combinations of unlocking numbers can be increased without greatly increasing the number of push-buttons and tumblers. This makes it possible to obtain a push-button lock device high in security at comparatively low cost without increasing the size of the holder case.

1. In a push-button lock device having a plurality of push-buttons provided on a holder case so as to be capable of extending and retracting therefrom in a surface thereof, a plurality of kinds of tumblers provided within the case correspondingly to the push-buttons to move toward a backside of the holder case when pushing the push-button, a slider provided within the holder case to move in a direction orthogonal to a moving direction of the tumbler, the slider urged in a lock position being allowed to an unlocking position by push-operating some of preset unlocking tumblers through the push-buttons, the push-button lock device characterized in that:
provided are a positioning mechanism for setting temporary fixing positions of the tumblers in a plurality of positions in a front-back direction of the holder case, and an intermediate mechanism for advancing, each time the push-button is pushed once, the temporary fixing position of the tumbler corresponding to the push-button toward the backside of the holder case one by one.

2. A push-button lock device according to claim 1, wherein the positioning mechanism has a return spring urging the tumbler onto a former unpushed position, a plurality of engaging portions formed in the tumbler in positions spaced in the front-back direction of the holder case, a positioning spring for being caught by any of the engaging portions to temporarily fix the tumbler.

3. A push-button lock device according to claim 2, further comprising a clear actuator having a plurality of positioning springs to be caught by the engaging portion to temporarily fix the tumbler and being movable in a direction orthogonal to a moving direction of the tumbler.

4. A push-button lock device according to claim 3, further comprising a clear tumbler for moving the clear actuator in order to disengage the positioning spring from the engaging portion of the tumbler and a clear button to push-operate this tumbler.

5. A push-button lock device according to any of claims 1 to 4, wherein the intermediate mechanism has a plurality of engaging projections formed in positions spaced in the front-back direction of the holder case, and a push-in arm having a tip to be caught by any of the engaging projections and a base coupled to the push-button.

6. A push-button lock device according to claim 5, further comprising a retraction member for swing the relevant push-in arm such that a tip of the push-in arm is out of a passage region of the tumbler when the push-button is not pushed, and the tip first enters the passage region when the push-button is pushed.
It is to be understood that the drawings and descriptive matter are in all cases to be interpreted as merely illustrative of the principles of the invention, rather than as limiting the same in any way, since it is contemplated that various changes may be made in various elements to achieve like results without departing from the spirit of the invention or the scope of the appended claims.
